(19) United States
(12) Patent Application Publication
(10) Pub. No.: US 2024/0159215 A1
(43) Pub. Date: May 16, 2024

(54) FAULT-TOLERANT CONTROL METHOD AND APPARATUS OF FLOATING WIND TURBINE

(71) Applicants: NORTH CHINA ELECTRIC POWER UNIVERSITY, Beijing (CN); HUANENG GROUP R&D CENTER CO LTD, Beijing (CN)

(72) Inventors: Ziqiu Song, Beijing (CN); Yang Hu, Beijing (CN); Fang Fang, Beijing (CN); Jizhen Liu, Beijing (CN); Xiaojiang Guo, Beijing (CN); Qinghua Wang, Beiging (CN); Jin Ju, Beijing (CN)

(21) Appl. No.: 18/234,268

(22) Filed: Aug. 15, 2023

(30) Foreign Application Priority Data
Nov. 4, 2022 (CN) 2022113775718

(51) Int. Cl. F03D 7/00

(52) U.S. Cl. CPC F03D 7/00; F05B 2270/32; F05B 2270/328; F05B 2270/331; F05B 2270/705

(57) ABSTRACT

A fault-tolerant control method and apparatus of a floating wind turbine are provided. The fault-tolerant control method and apparatus of a floating wind turbine can acquire a low-order nonlinear model of a pre-established floating wind turbine, establish a switching linear model of the floating wind turbine based on the low-order nonlinear model, acquire a modal parameter of the current floating wind turbine, and determine based on the modal parameter a sub-model that the floating wind turbine currently satisfies, so as to establish a switching sliding mode surface and a full-order state observer of the floating wind turbine based on the sub-model and the modal parameter, and further calculate a feedback output of a controller of the floating wind turbine according to the switching sliding mode surface and the full-order state observer.

### CROSS-REFERENCE TO RELEVANT APPLICATIONS

The present disclosure claims the priority to the Chinese patent application with the application number 202211377571.8, filed on Nov. 4, 2022 with Chinese Patent Office and entitled “FAULT-TOLERANT CONTROL METHOD AND APPARATUS OF FLOATING WIND TURBINE”, the contents of which are incorporated herein in its entirety by reference.

### TECHNICAL FIELD

The present disclosure relates to the technical field of wind turbine control, and more particularly, to a fault-tolerant control method and apparatus of a floating wind turbine.

### BACKGROUND ART

With large-scale installation and gradual saturation of onshore and coastal wind turbines in recent years, and due to that the large-scale onshore or coastal wind turbines may cause noise and visual impact to the mankind and even influence traffic, the utilizing of floating offshore wind turbines (FOWT) to obtain wind energy has become an inevitable choice.

The advantages of utilizing the deep-water floating offshore wind turbines supported by floating platforms lie in mainly: 1) wide range of suitable water depths; 2) better flexibility in deployment; 3) capacity of installing high-power wind turbines; and 4) lower cost in deeper water. However, FOWT also faces many challenges. For example, the floating platforms have more degrees of freedom, which aggravates the nonlinearity of the coupling system, and the harsh deep-sea environment includes turbulence, irregular waves and ocean currents, which affect the characteristics of the FOWT jointly. Moreover, the swinging motion of the FOWT will also lead to power fluctuations and increased mechanical loads, reducing the overall control efficiency of the floating wind turbine.

### SUMMARY

In view of this, the present disclosure aims at providing a fault tolerant control method and apparatus of a floating wind turbine, so as to alleviate the above technical problems.

In a first aspect, embodiments of the present disclosure provide a fault tolerant control method of a floating wind turbine, including steps of: acquiring a low-order nonlinear model of a pre-established floating wind turbine; establishing a switching linear model of the floating wind turbine based on the low-order nonlinear model, wherein the switching linear model includes a plurality of sub-models; acquiring a modal parameter of the current floating wind turbine, and determining, based on the modal parameter, a sub-model that the floating wind turbine currently satisfies; establishing a switching sliding mode surface and a full-order state observer of the floating wind turbine based on the sub-model and the modal parameter; and calculating a feedback output of a controller of the floating wind turbine according to the switching sliding mode surface and the full-order state observer, so as to perform a fault-tolerant control on the floating wind turbine through the feedback output of the controller.

In combination with the first aspect, embodiments of the present disclosure provide a first possible implementation of the first aspect, wherein the above low-order nonlinear model includes a drive-train model, a tower-top-displacement model, and a pitch-angle model of the floating wind turbine. The method further includes: acquiring a total axial force and a rotational moment acted on a rotor of the floating wind turbine, and establishing the drive-train model and the tower-top-displacement model according to the total axial force and the rotational moment.

In combination with the first possible implementation of the first aspect, embodiments of the present disclosure provide a second possible implementation of the first aspect, wherein the above step of establishing a switching linear model of the floating wind turbine based on the low-order nonlinear model includes: acquiring a steady-state point linearization expression including the total axial force and the rotational moment; and determining the switching linear model of the floating wind turbine based on the steady-state point linearization expression.

In combination with the second possible implementation of the first aspect, embodiments of the present disclosure provide a third possible implementation of the first aspect, wherein the above steady-state point linearization expression is expressed as:

δTᵣ=K_{Tω}δωᵣ+K_{Tβ}δβ+K_{Tv}δv+K_{Tξ}δ\ddot{ξ}

wherein δ represents a deviation between a current value and a steady-state value of a following variable, Tr represents the rotational moment, ωᵣ represents a rotor rotational speed, β represents a pitch angle (propeller pitch angle), v represents a wind speed, ξ represents a second derivative of a tower-top displacement, and K_{Tω}, K_{Tβ}, K_{Tv}, and K_{Tξ} all represent dynamic gains.

The switching linear model is expressed as:

$$\{ \begin{matrix}\dot{x} ( t ) = {A}_{σ ( t )} x ( t ) + {B}_{σ ( t )} {u}_{c} ( t ) + {B}_{d , σ ( t )} w ( t ) \\ y ( t ) = {C}_{σ ( t )} x ( t ) + {D}_{σ ( t )} {u}_{c} ( t ) + {H}_{d , σ ( t )} w ( t )\end{matrix}$$

x(t), u_{c}(t), w(t), and y(t) represent parameters of a state vector, a control input, a disturbance vector, and a system output over time respectively, σ(t) represents a switch signal, wherein the switch signal is used for instructing the sub-model that the floating wind turbine satisfies, to switch among the plurality of the sub-models, and the switch signal is constrained by an average residence time; and A, B, C, D, and H represent coefficient matrixes corresponding to the switch signal, respectively.

In combination with the third possible implementation of the first aspect, embodiments of the present disclosure provides a fourth possible implementation of the first aspect, wherein the above step of determining based on the modal parameter a sub-model that the floating wind turbine currently satisfies includes: determining, according to preset corresponding relationship between modal parameters and switch signals, the switch signal according to the modal parameter; and instructing the sub-model according to the switch signal.

In combination with the first aspect, embodiments of the present disclosure provide a fifth possible implementation of the first aspect, wherein the above step of establishing a switching sliding mode surface and a full-order state observer of the floating wind turbine based on the sub-model and the modal parameter includes: acquiring a historical modal parameter that meets a preset condition, wherein the preset condition includes: using, under a constant wind speed and a regular wave, a gain scheduling proportional integral control strategy to control the pre-established floating wind turbine, wherein the historical modal parameter is a steady-state value of the modal parameter obtained under the preset condition; calculating a model parameter of the sub-model according to the historical modal parameter; and establishing the switching sliding mode surface and the full-order state observer of the floating wind turbine according to the model parameter.

In combination with the fifth possible implementation of the first aspect, embodiments of the present disclosure provide a sixth possible implementation of the first aspect, wherein a feedback output of the controller of the above floating wind turbine includes: a compensation value feedback output of the full-order state observer, a state feedback output of the floating wind turbine, and a disturbance feedback output; and the step of calculating a feedback output of a controller of the floating wind turbine according to the switching sliding mode surface and the full-order state observer includes: calculating the compensation value feedback output, the state feedback output, and the disturbance feedback output, respectively; and superimposing the compensation value feedback output, the state feedback output, and the disturbance feedback output, to generate the feedback output of the controller of the floating wind turbine.

In a second aspect, embodiments of the present disclosure further provide a fault-tolerant control apparatus of a floating wind turbine, including: an acquisition module configured for acquiring a low-order nonlinear model of a pre-established floating wind turbine; an establishment module configured for establishing a switching linear model of the floating wind turbine based on the low-order nonlinear model, wherein the switching linear model comprises a plurality of sub-models; a determination module configured for acquiring a modal parameter of the current floating wind turbine, and determining, based on the modal parameter, a sub-model that the floating wind turbine currently satisfies; a calculation module configured for establishing a switching sliding mode surface and a full-order state observer of the floating wind turbine based on the sub-model and the modal parameter; and a control module configured for calculating a feedback output of a controller of the floating wind turbine according to the switching sliding mode surface and the full-order state observer, so as to perform a fault-tolerant control on the floating wind turbine through the feedback output of the controller.

In a third aspect, embodiments of the present disclosure further provide an electronic device, including a memory, a processor, and a computer program stored on the memory and operable on the processor, wherein when the processor executes the computer program, the steps of the method as mentioned in the first aspect above are implemented.

In a fourth aspect, embodiments of the present disclosure further provide a computer-readable storage medium, wherein a computer program is stored on the computer-readable storage medium, and when the computer program is operated by a processor, the steps of the method as mentioned in the first aspect above are executed.

The embodiments of the present disclosure have brought the following beneficial effects.

The fault-tolerant control method and apparatus provided by the embodiments of the present disclosure are capable of acquiring a low-order nonlinear model of a pre-established floating wind turbine, establishing a switching linear model of the floating wind turbine based on the low-order nonlinear model, and acquiring a modal parameter of the current floating wind turbine, determining, based on the modal parameters, a sub-model that the floating wind turbine currently satisfied, establishing a switching sliding mode surface and a full-order state observer of the floating wind turbine based on the sub-model and the modal parameter, and further calculating a feedback output of a controller of the floating wind turbine according to the switching sliding mode surface and the full-order state observer, so as to perform a fault-tolerant control on the floating wind turbine through the feedback output of the controller. In the whole process of the fault-tolerant control, the low-order nonlinear model characteristics of the floating wind turbine itself have been fully considered, so that the characteristics of the floating wind turbine may be well embodied in the model, thereby improving the effect of the fault-tolerant control; and at the same time, the robustness and self-adaptability of the whole control process may be increased, ensuring the fault-tolerant operation performance of the floating wind turbine under various or extreme working conditions.

Other features and advantages of the present disclosure will be illustrated in the following description, and partially become obvious from the description, or understood by implementing the present disclosure. The objectives and other advantages of the present disclosure are realized and obtained from the description, the claims, and the structures specifically indicated in the drawings.

In order to make the above objectives, the features, and the advantages of the present disclosure more obvious and understandable, preferred embodiments are specifically illustrated to make detailed description below in conjunction with the drawings.

### BRIEF DESCRIPTION OF DRAWINGS

In order to illustrate the technical solutions in the embodiments of the present disclosure or in the prior art more clearly, the drawings that need to be used in the description of the embodiments or the prior art are briefly introduced as follows. Obviously, the drawings in the following description show some embodiments of the present disclosure. For those skilled in the art, other drawings can also be obtained according to these drawings without making any creative efforts.

FIG. 1 is a flowchart of a fault-tolerant control method of a floating wind turbine provided by embodiments of the present disclosure;

FIGS. 2(a)-2(f) are schematic diagrams showing simulation results provided by embodiments of the present disclosure;

FIG. 3 is a structural schematic diagram of a fault-tolerant control apparatus of a floating wind turbine provided by embodiments of the present disclosure; and

FIG. 4 is a structural schematic diagram of an electronic device provided by embodiments of the present disclosure.

### DETAILED DESCRIPTION OF EMBODIMENTS

In order to make objectives, technical solutions, and advantages of embodiments of the present disclosure clearer, the technical solutions in the present disclosure will be described below clearly and completely in conjunction with the drawings, and apparently, the described embodiments are some but not all embodiments of the present disclosure. All of other embodiments, obtained by a person skilled in the art based on the embodiments of the present disclosure without making any creative efforts, shall fall into the scope of protection of the present disclosure.

At present, the utilizing of the floating offshore wind turbine to obtain wind energy has become an inevitable choice. However, the researches on the floating wind turbine still faces many challenges, including but not limited to the following contents:
1) Complex characteristics: The floating platform adds at least 6 degrees of freedom to the control system of the floating wind turbine, aggravating the nonlinearity of the coupling system, and the harsh deep-sea environment includes turbulence, irregular waves and ocean currents, etc., which affect the characteristics of the floating wind turbine jointly.
2) Multiple-control requirements: the swinging motion of the floating wind turbine leads to power fluctuations and increased mechanical loads, resulting in that the stable and safe operation of the whole system requires effective design of performing power control, structure control, load control, and coordinated control among them under various working conditions.
3) Unsatisfactory fault tolerance: sub-devices, related sensors, actuators and other components of the floating wind turbine may fail and are difficult to get timely repair and maintenance due to the long distance from the shore, where the possible failures may reduce the output power quality and shorten the life of the floating wind turbine.

Moreover, the object that the existing wind turbine fault-tolerant control is mainly focused on the onshore wind turbine or coastal wind turbine, the fault-tolerant control scheme to the floating offshore wind turbine is less. Based on this, a fault-tolerant control method and apparatus of a floating wind turbine provided by embodiments of the present disclosure may effectively alleviate the above technical problems.

For ease of understanding of the present embodiment, firstly, a fault-tolerant control method of a floating wind turbine disclosed in embodiments of the present disclosure is introduced in detail.

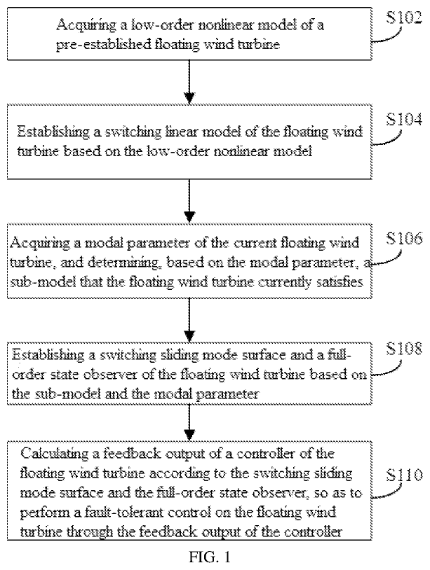

In a possible implementation, embodiments of the present disclosure provide a fault-tolerant control method of a floating wind turbine, and a flowchart of a fault-tolerant control method of a floating wind turbine is shown in FIG. 1, wherein the method includes the following steps.

Step S102, acquiring a low-order nonlinear model of a pre-established floating wind turbine.

In practical application, the floating wind turbine in the embodiments of the present disclosure refers to the deep-water floating offshore wind turbine, the low-order nonlinear model of which generally includes a drive-train model, a tower-top-displacement model, and a pitch-angle model of the floating wind turbine.

Generally, in order to obtain each of the above low-order nonlinear models, it is usually assumed that the floating wind turbine is on the windward/wave ward side. Based on such assumption, left and right bending motions of the tower, and horizontal swinging, heaving, rolling and tilting, and yawing motion of the floating platform are microscopic and may be ignored. Therefore, for the floating wind turbine in the embodiments of the present disclosure, the degrees of freedom of the horizontal surge translation ξₛᵤ and the pitch tilting rotation angle θₚₚ are considered.

In specific implementation, what the above low-order nonlinear model referred to is a floating platform dynamic model. Based on such floating platform dynamic model, when establishing the low-order nonlinear model, it may acquire a total axial force and a rotational moment that are applied on a rotor of the floating wind turbine, and a drive-train model and a tower-top-displacement model are established based on the total axial force and the rotational moment.

Specifically, the rotor aerodynamic load of a floating wind turbine is usually directly reflected in the rotation of the blades and the vibration of the tower top, therefore, it may be calculated by the blade element momentum theory (BEM). In the theory of blade element momentum, the blade is divided into blade element units, and the aerodynamic characteristics of the blade element units to the airfoil depend on the shape of the airfoil, and the force applied on the blade element unit may be calculated as:

$${dF}_{L , k} = \frac{1}{2} {ρ}_{a} {cC}_{L} ( {α}_{k} ) {V}_{r , k}^{2} dr$$

$${dF}_{D , k} = \frac{1}{2} {ρ}_{a} {cD}_{D} ( {α}_{k} ) {V}_{r , k}^{2} dr .$$

In the above, F_{L,k} and F_{D,k} indicate the lifting force and dragging force of the k^{th} blade; ρ_{α} indicates the air density; c indicates the airfoil chord length of the blade element; C_{L} (αk) and C_{D} (αk) indicate coefficients of the lifting force and the dragging force, and are related to the angle of attack αk; V_{r,k} indicates the relative wind speed of the blade k; r indicates the distance from the blade element unit to the blade root. Therefore, the total axial force and the rotational moment applied on the rotor of the floating wind turbine may be expressed as:

$${F}_{t} = {\sum }_{k = 1}^{3} {\int }_{r = 0}^{R} ( {dF}_{L , k} cos {φ}_{k} + {dF}_{D , k} sin {φ}_{k} )$$

$${T}_{r} = {\sum }_{k = 1}^{3} {\int }_{r = 0}^{R} {rdF}_{y , k} = {\sum }_{k = 1}^{3} {\int }_{r = 0}^{R} ( {rdF}_{D , k} cos {φ}_{k} - {rdF}_{L , k} sin {φ}_{k} ) .$$

In the above, φₖ represents the inflow angle, and has a nonlinear relationship with the angle of attack αₖ, the tower-top displacement ξ, and the pitch angle β, and the nonlinear relationship is expressed as: φₖ=F (αₖ, β, ξ(ξₛᵤ, θₚₚ)).

In the above, R represents the blade length, F_{y,k} is the radial force that the blade is subjected to, and based on the total axial force and the rotational moment, the drive-train model of the above low-order nonlinear model may be modeled as the two-mass block dynamic model, which is expressed as following:

$$\{ \begin{matrix}{J}_{r} {\dot{ω}}_{r} = {T}_{r} - {K}_{s} ϕ - {D}_{s} {ω}_{r} + {D}_{s} {ω}_{g} / {N}_{g} \\ {J}_{g} {\dot{ω}}_{g} = {K}_{s} ϕ / {N}_{g} + {D}_{s} {ω}_{r} / {N}_{g} - {D}_{s} {ω}_{g} / {N}_{g}^{2} - {T}_{g} \\ \dot{ϕ} = {ω}_{r} - {ω}_{g} / {N}_{g}\end{matrix} .$$

In the above, Jᵣ and J_{g} indicate moments of inertia of the rotor and the generator, respectively; ωᵣ and ω_{g} indicate rotational speeds of the rotor and the generator, respectively; ϕ indicates the torsion angle of the shaft; T_{g} indicates the electromagnetic torque of the generator; Kₛ and Dₛ represent the elastic coefficient and the damping coefficient of the flexible shaft, respectively; and N_{g} represents the gearbox gear ratio of the floating wind turbine.

Further, the tower-top-displacement model may be expressed as in the form of second-order system as following:

\ddot{ξ}+2ζₜωₜ\dot{ξ}+ωₜ²ξ=kₜωₜ²Fₜ.

In the above, ζₜ and ωₜ indicate the damping ratio and the natural angular frequency of the tower, respectively; kₜ is the model gain of the tower; and ξ is the displacement of the tower top.

Further, in the low-order nonlinear model, the pitch-angle model refers to the pitch-angle actuator model, wherein the pitch-angle actuator is a servo module that may be modeled as a first-order inertial model with links of amplitude limiting and speed limiting, which is expressed as:

\dot{β}=(βᵣ−β)/τₚ

In the above, β represents the pitch angle; τₚ represents the time constant of the pitch-angle actuator; βᵣ represents the input obtained by the pitch-angle actuator from the pitch-angle controller.

Step S104, establishing a switching linear model of the floating wind turbine based on the low-order nonlinear model.

In the above, the switching linear model in the embodiments of the present disclosure includes a plurality of sub-models.

Step S106, acquiring a modal parameter of the current floating wind turbine, and determining, based on the modal parameter, a sub-model that the floating wind turbine currently satisfies.

In the above, the modal parameter of the current floating wind turbine acquired in the step generally includes state data and environmental data of the floating wind turbine. Specifically, the state data further includes: a blade rotational speed, a generator rotational speed, a torque, a fore-aft displacement of the tower top, a derivative of the fore-aft displacement of the tower top, and a pitch angle, etc., and the environmental data generally includes a wind speed and a wave height.

Step S108, establishing a switching sliding mode surface and a full-order state observer of the floating wind turbine based on the sub-model and the modal parameter;

Step S110, calculating a feedback output of a controller of the floating wind turbine according to the switching sliding mode surface and the full-order state observer, so as to perform a fault-tolerant control on the floating wind turbine through the feedback output of the controller.

The fault-tolerant control method of the floating wind turbine provided by the embodiments of the present disclosure is capable of acquiring a low-order nonlinear model of a pre-established floating wind turbine, establishing a switching linear model of the floating wind turbine based on the low-order nonlinear model, and acquiring a modal parameter of the current floating wind turbine, determining, based on the modal parameter, the sub-model that the floating wind turbine currently satisfies, establishing a switching sliding mode surface and a full-order state observer of the floating wind turbine based on the sub-model and the modal parameter, and further calculating a feedback output of a controller of the floating wind turbine according to the switching sliding mode surface and the full-order state observer, so as to perform a fault-tolerant control on the floating wind turbine through the feedback output of the controller. In the whole process of the fault-tolerant control, the low-order nonlinear model characteristics of the floating wind turbine itself have been fully considered, so that the characteristics of the floating wind turbine may be well embodied in the model, thereby improving the effect of the fault-tolerant control; and at the same time, the robustness and adaptability of the whole control process may be increased, ensuring the fault-tolerant operation performance of the floating wind turbine under various or extreme working conditions.

In the specific implementation, in a plurality of the low-order nonlinear models as mentioned above, the total axial force and the rotational moment of the rotor are main nonlinear factor parts. Therefore, in the above step S104, when establishing the switching linear model of the floating wind turbine, it is generally necessary to obtain the steady-state point linearization expression including the total axial force and the rotational moment, and then determine the switching linear model of the floating wind turbine based on the steady-state point linearization expression.

Specifically, assuming that the total axial force is obtained through a measurable external pressure sensor, which may represent the wind and wave effects coupled on the tower top and the floating platform, and through nonlinear dynamic models and related experiments, it is found that the rotational moment is closely related to the wind speed, the pitch angle, the rotor rotational speed, and the second derivative of the tower top displacement, which may be linearized at each steady-state operating point as:

δTᵣ=K_{Tω}δωᵣ+K_{Tβ}δβ+K_{Tv}δv+K_{Tξ}δ\ddot{ξ}.

In the above, δ represents a deviation between a current value and a steady-state value of a following variable, Tr represents the rotational moment, ωᵣ represents the rotor rotational speed, β represents the pitch angle, v represents the wind speed, ξ represents the second derivative of the tower-top displacement, and K_{Tω}, K_{Tβ}, K_{Tv}, and K_{Tξ} all represent dynamic gains.

Specifically, the each of the above dynamic gains may be calculated as:

$${K}_{T ω} = \frac{\partial {T}_{r}}{\partial {ω}_{r}} {\vert}_{{ω}_{r}^{*}} {K}_{T β} = \frac{\partial {T}_{r}}{\partial β} {\vert}_{{β}^{*}} {K}_{T v} = \frac{\partial {T}_{r}}{\partial v} {\vert}_{v *} {K}_{T ξ} = \frac{\partial {T}_{r}}{\partial \ddot{ξ}} {\vert}_{{\ddot{ξ}}^{*}} .$$

In the above, (∂Tᵣ/∂ωᵣ), (∂Tᵣ/∂β), (∂Tᵣ/∂v), (∂Tᵣ/∂\ddot{ξ}) are partial derivatives of the rotational moment with respect to the rotor rotational speed, the pitch angle, the wind speed and the second derivative of the tower-top displacement, at the steady-state points ω*ᵣ, β*, v*, \ddot{ξ}*.

Further, based on the above steady-state point linearization expression, the switching linear model of the above floating wind turbine is expressed as:

$$\{ \begin{matrix}\dot{x} ( t ) = {A}_{σ ( t )} x ( t ) + {B}_{σ ( t )} {u}_{c} ( t ) + {B}_{d , σ ( t )} w ( t ) \\ y ( t ) = {C}_{σ ( t )} x ( t ) + {D}_{σ ( t )} {u}_{c} ( t ) + {H}_{d , σ ( t )} w ( t )\end{matrix}$$

x(t), u_{c}(t), w(t), and y(t) represent parameters of a state vector, a control input, a disturbance vector, and a system output over time respectively, σ(t) represents a switch signal, wherein the switch signal is used for instructing the sub-model that the floating wind turbine satisfies to switch among the plurality of the sub-models, and the switch signal is constrained by an average residence time; and A, B, C, D, and H represent coefficient matrixes corresponding to the switch signal, respectively.

In the above, the state vector represented by x(t) is related to the state data source in the modal parameter of the current floating wind turbine, and its vector form is expressed as x=[δωᵣ, δω_{g}, δϕ, δξ, δ\dot{ξ}]^{T}.

u_{c}(t) is related to the pitch angle β, which may be expressed as u_{c}=δβ; w(t) and y(t) are expressed as w=[δv, δFₜ]^{T}, y=δωᵣ, respectively.

σ(t) is used to indicate the sub-model, assuming there are M sub-models and each of the sub-models is represented by i, it is expressed as: σ(t)→{1,2, . . . M}. Therefore, the above coefficient matrixes also have the mapping relationship: A_{σ(t)}→Aᵢ, that is, σ(t) is used to indicate the value of specific i, so as to determine the sub-model.

In the above, when determining the sub-model that the floating wind turbine currently satisfies, it is necessary to determine, according to a preset corresponding relationship between modal parameters and switch signals, the switch signal according to the modal parameter, and instructing the sub-model according to the switch signal.

Specifically, the above coefficient matrixes may be expressed as follows:

$${A}_{i} = [ \begin{matrix}\frac{{K}_{T ω}^{i} - {D}_{s}}{{J}_{r}} & \frac{{D}_{s}}{{J}_{r} {N}_{g}} & - \frac{{K}_{g}}{{J}_{r}} & - \frac{{K}_{T ξ}^{i} {ω}_{t}^{2}}{{J}_{r}} & \frac{- 2 {K}_{T ξ}^{i} {ζ}_{t} {ω}_{t}}{{J}_{r}} \\ - \frac{{D}_{s}}{{J}_{g} {N}_{g}} & - \frac{{D}_{s}}{{J}_{g} {N}_{g}} & \frac{{K}_{s}}{{J}_{g} {N}_{g}} & 0 & 0 \\ 1 & - 1 / {N}_{g} & 0 & 0 & 0 \\ 0 & 0 & 0 & 0 & 1 \\ 0 & 0 & 0 & - {ω}_{t}^{2} & - 2 {K}_{T ξ}^{i} {ζ}_{t} {ω}_{t}\end{matrix} ]$$

$${B}_{i} = {[ {K}_{T β}^{i} / {J}_{r} 0000 ]}^{T} {C}_{i} = [ 10000 ]$$

$${B}_{d , i} = {[ \begin{matrix}{K}_{Tv}^{i} / {J}_{r} & 0 & 0 & 0 & 0 \\ 0 & 0 & 0 & 0 & {ω}_{t}^{2}\end{matrix} ]}^{T} {D}_{i} = [ 0 ] {H}_{i} = [ 00 ]$$

Further, in order to ensure that the switching of the sub-model above does not affect the stability of the system, and make the switching more reasonable, in the embodiments of the present disclosure, the average residence time technology is used to constrain the switch signal. Therefore, for the switch signal, the average residence time generally satisfies the following formula:

$${N}_{σ} ( {t}_{1} , {t}_{2} ) ⩽ {N}_{0} + \frac{{t}_{2} - {t}_{1}}{{τ}_{a}}$$

In the above, t₂>t₁>0, and the biased scalar N₀≥0, wherein N_{σ}(t₁, t₂) indicates the number of times that switching is performed through the switch signal in this time interval.

For any sub-system i, there are two scalars λᵢ and μᵢ greater than 0, and the following formula is satisfied:

x(t)≤μᵢx₀e^{(-λ}^{ᵢ}^{(t-t}^{₀}⁾⁾

In the above, x₀ is the system state initial value, and t₀ is the initial time.

In order to ensure that the input state of the system is stable, the average residence time is required to satisfy:

$${τ}_{a} \geq {τ}_{a}^{*} = \frac{ln \overline{μ}}{{λ}^{*}} ,$$

wherein μ̅=max{μᵢ}, λ̅=max{λᵢ}, and 0<λ*<λ̅.

Further, after determining the sub-model based on the above switch signal, it may further establish the switching sliding mode surface and the full-order state observer of the floating wind turbine based on the sub-model and the modal parameter.

In the above, in the embodiments of the present disclosure, before the calculation based on the modal parameter, it is necessary to acquire a historical modal parameter that meets the preset condition, wherein the preset condition includes: using, under a constant wind speed and a regular wave, a gain scheduling proportional integral control strategy to control the pre-established floating wind turbine, wherein the historical modal parameter is a steady-state values of the modal parameter obtained under the preset condition; then calculate a model parameter of the sub-model according to the historical modal parameter; and further establish the switching sliding mode surface and the full-order state observer of the floating wind turbine according to the model parameter.

Specifically, when acquiring the historical modal parameter that meets the preset condition, it may enable the pre-established floating wind turbine to be kept under a constant wind speed and regular wave, and the pre-established floating wind turbine may be controlled by applying the gain scheduling proportional integral control strategy, so as so obtain the steady-state value of each state of the pre-established floating wind turbine is under the steady state.

Further, each state of the pre-established floating wind turbine is set as the steady-state value, then the pre-established floating wind turbine is controlled to be in the on/off state to do a step response test, and the gain data of the main state of the pre-established floating wind turbine is recorded, so as to obtain the model parameters required by the sub-models, and the model parameters may be used as the dynamic gains in the above steady-state point linearization expression, which may be expressed as follows:

$${K}_{T ω} = \frac{\partial {T}_{r}}{\partial {ω}_{r}} {\vert}_{{ω}_{r}} {K}_{T β} = \frac{\partial {T}_{r}}{\partial β} {\vert}_{β *} {K}_{T v} = \frac{\partial {T}_{r}}{\partial v} {\vert}_{v *} {K}_{T ξ} = \frac{\partial {T}_{r}}{\partial \ddot{ξ}} {\vert}_{\ddot{ξ} *}$$

Then the switching sliding mode surface and the full-order state observer are calculated.

Generally, the switching sliding mode surface of the floating wind turbine is defined as:

Sᵢ(t)=Gᵢy(t)−∫₀^{t} [symbol] ᵢ(τ)dτ.

In the above, Gᵢ is an optional gain matrix, so that GᵢCᵢBᵢ is reversible, and [symbol] ᵢ is an estimated compensation value which may be obtained through the full-order state observer.

Further, the full-order state observer is then expressed as:

\dot{ϑ}(t)=(MᵢĀᵢ−LᵢCᵢ)ϑ(t)+Hᵢy

In the above, ϑ(t) is the augmented vector of the state vector, and satisfies ϑ=Mᵢ\tilde{x}=\tilde{x}+Uᵢ\tilde{y}, wherein \tilde{x} and \tilde{y} indicate observations by the state vector and the system output; and Mi and Li are state auxiliary matrix and control input auxiliary matrix respectively, and satisfy the relationships as follows:

MᵢBᵢ=0,

Rank(Mᵢ)=n−m,

Hᵢ=Lᵢ+(LᵢCᵢ−MᵢĀᵢ)Uᵢ,

Mᵢ=Iₙ+UᵢCᵢ.

In the above, Uᵢ is the gain compensation auxiliary matrix, n is the number of system states, m is the number of system control inputs, and Iₙ is the n-dimensional unit matrix. Therefore, the gain compensation of the full-order state observer may be defined as:

[symbol]

ᵢ(t)=−Kᵢ (ϑ(t)−Uᵢy(t)).

In the above, the relevant parameters may be obtained by solving the following linear matrix inequality:

$$[ \begin{matrix}{\overline{P}}_{i , x} {\overline{A}}_{i}^{T} - {\overline{K}}_{i}^{T} {B}_{i}^{T} + {\overline{A}}_{i} {\overline{P}}_{i , x} - {B}_{i} {\overline{K}}_{i} & - {B}_{i} {\overline{K}}_{i} & {\overline{B}}_{i , d} & {μ}_{i} {\overline{P}}_{i , x} \\ * & {\overline{P}}_{i , x}^{T} {\overline{A}}_{i}^{T} {M}_{i}^{T} + {M}_{i} {\overline{A}}_{i} {\overline{P}}_{i , e} - L & {M}_{i} {\overline{B}}_{i , d} & 0 \\ * & * & - {I}_{d} & 0 \\ * & * & * & - {I}_{n}\end{matrix} ] < 0$$

And, the parameter matrix in the full-order state observer may be calculated as:

Kᵢ=K̅ᵢP̅_{i,x}⁻¹, Lᵢ=L̅ᵢP̅_{i,e}⁻¹C⁻¹.

In the above, P_{i,x} and P_{i,e} matrixes represent the gain auxiliary matrixes, and specifically, P_{i,x} represents the gain auxiliary matrix of the state, and P_{i,e} represents the gain auxiliary matrix of the observation error.

Further, the feedback output of the controller of the floating wind turbine obtained by the calculation based on the above switching sliding mode surface and the full-order state observer includes: a compensation value feedback output of the full-order state observer, a state feedback output of the floating wind turbine, and a disturbance feedback output. Therefore, when calculating the feedback output of the controller of the floating wind turbine according to the switching sliding mode surface and the full-order state observer, the compensation value feedback output, the state feedback output, and the disturbance feedback output are mainly calculated, respectively, and then the compensation value feedback output, the state feedback output, and the disturbance feedback output are superimposed, to generate the feedback output of the controller of the floating wind turbine.

Specifically, the feedback output of the controller of the floating wind turbine may be expressed as in the form as follows:

u_{eq}=u_{lƒ}u_{xƒ}+u_{dƒ}.

In the above, u_{lƒ} represents the compensation value feedback output of the full-order state observer; u_{xƒ} represents the state feedback output of the floating wind turbine; and u_{dƒ} represents the disturbance feedback output.

Further, each of the feedback outputs above may be further expressed as:

u_{lƒ}=−Kᵢϑ(t)+KᵢUᵢy(t)

u_{xƒ}=−GᵢCᵢAᵢx(t)

u_{dƒ}=−GᵢCᵢB_{d,i}w(t)

Further, in addition to the feedback outputs related to the above disturbance, other related outputs of the controller may be obtained by calculation, however, it is difficult to accurately acquire the system disturbance, therefore, in embodiments of the present disclosure, a self-adaptive rate is further designed to solve this problem.

Specifically, it may be defined that there is an upper bound on the system disturbance, which may be expressed as:

∥ w(t) ∥≤κ [symbol] (t).

In the above, w(t) represents the above disturbance vector, κ represents a positive scalar, [symbol] (t) represents a positive definite function which is related to the disturbance.

In order to make the track of the floating wind turbine running on the defined switching sliding mode surface, the above disturbance feedback output may be rewritten as: u_{dƒ}=−(εᵢ+κGᵢCᵢB_{d,i} [symbol] (t))sat(Sᵢ(t)/Δᵢ).

In the above, εᵢ is an adjustable relatively small threshold; Δᵢ is a positive adjustable constant; κ may be estimated as \tilde{κ} and has the following self-adaptive rate that is expressed as:

$$\dot{\tilde{κ}} = \{ \begin{matrix}0 & ‖ {S}_{i} ( t ) ‖ \leq {Ω}_{i} \\ \frac{1}{{ρ}_{i}} ( ‖ {G}_{i} {C}_{i} {B}_{d , i} ‖ ) ℒ ( t ) ‖ {S}_{i} ( t ) ‖ & ‖ {S}_{i} ( t ) ‖ > {Ω}_{i}\end{matrix} .$$

In the above, ρᵢ is a defined positive gain, and Ωᵢ represents a small positive scalar.

The feedback output of the controller of the above floating wind turbine is obtained by the calculation in a computer, inputted into the actuator of the floating wind turbine and acted on the floating wind turbine, thereby realizing the fault-tolerant control of the floating wind turbine.

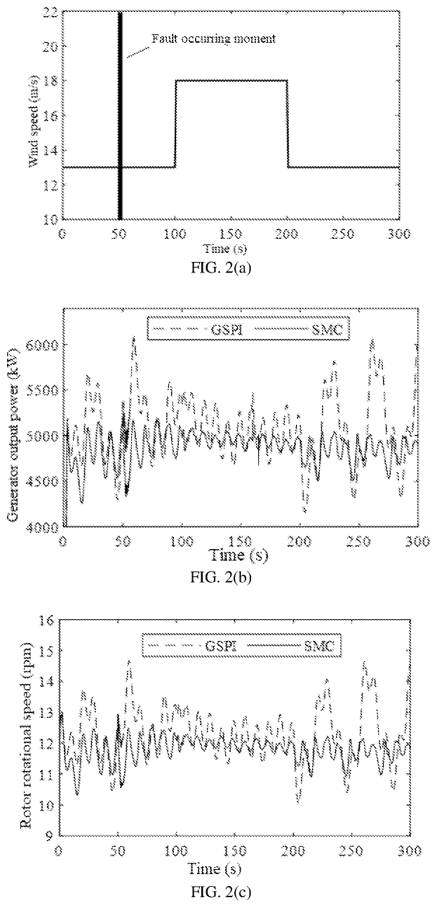

Further, the fault-tolerant control technology of the embodiments of the present disclosure and the gain scheduling proportional integral controller (GSPI) are subjected to comparison-simulation verification based on FAST, wherein the simulation object is NREL 5MW floating offshore wind turbine, the floating platform is the OC3-Hywind spar type platform, and the sampling interval of the simulation is 0.01 second. The wind used in the simulation is the step wind with a rise-fall range (speed range) of 13 m/s to 18 m/s, the wave used is a sine wave, and the fault is set and selected as a sudden peak occurring when the pitch-angle actuator is at 50 second, the simulation results are shown in FIGS. 2(a)-2(f).

FIG. 2(a) is a time-domain diagram of wind speed and a schematic diagram when a fault occurs, and FIG. 2(b) and FIG. 2(c) show that under the situation of the wind speed step changes and the fault occurs in the actuator, compared to GSPI, the fault-tolerant control technology of the embodiments of the present disclosure may regulate the power of the generator and the rotor speed well, and the fluctuation is small.

When a fault occurs in the actuator, the fault-tolerant control technology of the embodiments of the present disclosure may improve the power capture performance of the subsequent floating wind turbine, and compared with the GSPI variance, the variance is reduced by 65.7%, and the power fluctuation is relatively small.

As shown in FIG. 2(d), the performance of the pitch controller of GSPI degrades, and is difficult to recover quickly after a fault occurs in the actuator. However, the fault-tolerant control technology of the embodiments of the present disclosure may immediately compensate for the execution deviation caused by the fault, and may also compensate for the changes of wind, waves and other environments through self-adaptive gains. In addition, it may be seen from FIG. 2(e) and FIG. 2(f), the fault-tolerant control technology of the embodiments of the present disclosure may further enable the floating wind turbine to obtain a better platform pitch and fore-aft displacement relative to GSPI.

Therefore, the fault-tolerant control method proposed in the embodiments of the present disclosure may effectively handle unknown faults that occur in the floating wind turbine or external disturbances, without needing to perform the fault detection or fault isolation, which may reduce the impact on the floating wind turbine brought by the faults, and improve the performance of the floating wind turbine under the faults.

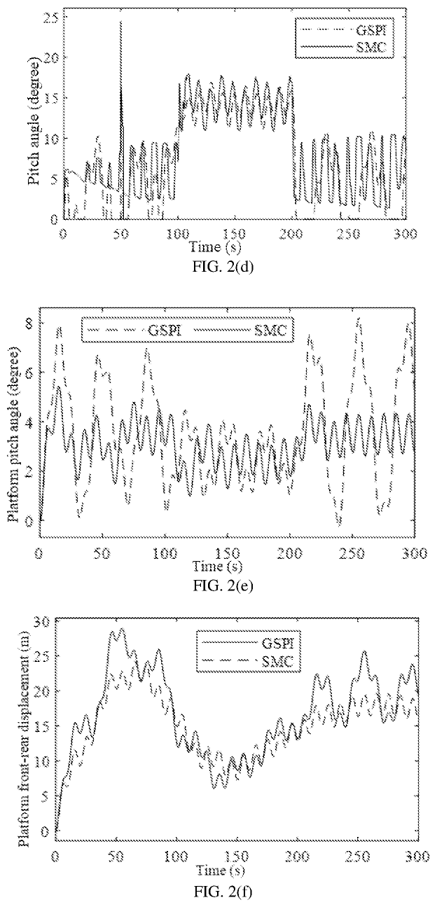

Further, embodiments of the present disclosure further provide a fault-tolerant control apparatus of a floating wind turbine, and a structural schematic diagram of the fault-tolerant control apparatus of the floating wind turbine is shown in FIG. 3, wherein the apparatus includes:

an acquisition module 30 configured for acquiring a low-order nonlinear model of a pre-established floating wind turbine;

an establishment module 32 configured for establishing a switching linear model of the floating wind turbine based on the low-order nonlinear model, wherein the switching linear model includes a plurality of sub-models;

a determination module 34 configured for acquiring a modal parameter of the current floating wind turbine, and determining, based on the modal parameters, a sub-model that the floating wind turbine currently satisfies;

a calculation module 36 configured for establishing a switching sliding mode surface and a full-order state observer of the floating wind turbine based on the sub-model and the modal parameter; and

a control module 38 configured for calculating a feedback output of a controller of the floating wind turbine according to the switching sliding mode surface and the full-order state observer, so as to perform a fault-tolerant control on the floating wind turbine through the feedback output of the controller.

The fault-tolerant control apparatus of the floating wind turbine provided by the embodiments of the present disclosure has the same technical features as the fault-tolerant control method of the floating wind turbine provided by the above embodiments, so that it may also solve the same technical problems and achieve the same technical effects.

Further, embodiments of the present disclosure further provide an electronic device, including: a memory, a processor, and a computer program stored on the memory and operable on the processor, wherein when the processor executes the computer program, the steps of the above method are implemented.

Embodiments of the present disclosure further provide a computer-readable storage medium, wherein the computer-readable storage medium stores a computer program, and the computer program, when executed by the processor, implement the steps of the above method.

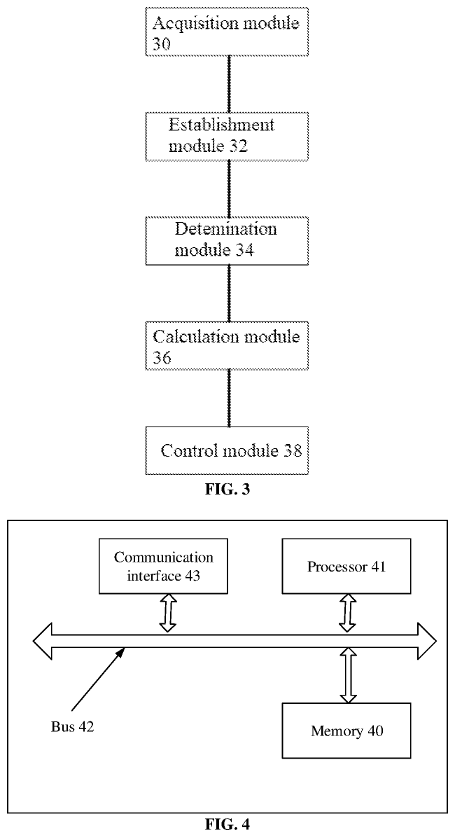

Further, embodiments of the present disclosure further provide a structural schematic diagram of electronic device, and as shown in FIG. 4, a structural schematic diagram of the electronic device is shown, wherein the electronic device includes a processor 41 and a memory 40, wherein the memory 40 stores computer-executable instructions that can be executed by the processor 41, and the processor 41 executes the computer-executable instructions so as to implement the above method.

In the implementation shown in FIG. 4, the electronic device further includes a bus 42 and a communication interface 43, wherein the processor 41, the communication interface 43, and the memory 40 are connected via the bus 42.

In the above, the memory 40 may include a high-speed random-access memory (RAM), and also may include a non-volatile memory, for example, at least one disk memory. Communication between this system network element and at least one other network element is achieved through at least one communication interface 43 (possibly wired or wireless), wherein Internet, Wide Area Network, local network, Metropolitan Area Network and so on may be used. The bus 42 may be an ISA (Industrial Standard Architecture) bus, PCI (Peripheral Component Interconnect) bus or EISA (Extended Industry Standard Architecture) bus, etc. The bus 42 may be an address bus, a data bus, a control bus and so on. For ease of representation, the bus is represented merely with one two-way arrow in FIG. 4, but it does not mean that there is only one bus or one type of bus.

The processor 41 may be an integrated circuit chip with a signal processing function. In an implementation process, various steps of the above method may be completed by an integrated logic circuit of hardware in the processor 41 or instructions in a software form. The above processor 41 may be a general-purpose processor, including a central processing unit (CPU for short), a network processor (NP for short), etc., and also may be a digital signal processor (DSP for short), an application specific integrated circuit (ASIC for short), a field-programmable gate array (FPGA for short) or other programmable logic devices, discrete gates, transistor logic devices, or discrete hardware components. The general-purpose processor may be a microprocessor or the processor also may be any conventional processor and so on. The steps in the method disclosed in combination with the embodiments of the present disclosure may be directly embodied as being carried out and completed by hardware decoding processor, or carried out and completed by hardware and software modules in the decoding processor. The software module may be located in a mature storage medium in the art, such as a random-access memory, a flash memory, a read-only memory, a programmable read-only memory or an electrically erasable programmable memory, and register. The storage medium is located in the memory, wherein the processor 41 reads the information in the memory, and completes the foregoing method in combination with its hardware.

A computer program product of the fault-tolerant control method and apparatus of a floating wind turbine provided in embodiments of the present disclosure includes a computer-readable storage medium in which a program code is stored, and instructions included in the program code may be used to implement the method described in the method embodiments in the preceding. Reference may be made to the method embodiments for specific implementation, which will not be repeated redundantly herein.

A person skilled in the art could clearly know that for the sake of convenience and conciseness of description, reference can be made to corresponding processes in the above method embodiments for specific operation processes of the device described in the above, and they will not be repeated redundantly herein.

In addition, in the description of the embodiments of the present disclosure, unless otherwise specified and defined explicitly, terms “mount”, “join”, and “connect” should be construed in a broad sense. For example, a connection may be a fixed connection, a detachable connection, or an integrated connection; it may be a mechanical connection, or also may be an electrical connection; it may be a direct connection, an indirect connection through an intermediate medium, or an inner communication between two elements. For a person skilled in the art, specific meanings of the above terms in the present disclosure may be understood according to specific circumstances.

If the function is realized in a form of software functional unit and is sold or used as an individual product, it may be stored in one computer readable storage medium. Based on such understanding, the essence of the technical solution of the present disclosure, a part of the technical solution which contributes to the prior art, or a part of the technical solution may be embodied in the form of a software product. The computer software product is stored in a storage medium, including several instructions which are used to make a computer device (which may be a personal computer, a server, or a network device, etc.) implement all or part of the steps of the methods described in the various embodiments of the present disclosure. The aforementioned storage medium includes various media in which program codes can be stored, such as U disk, mobile hard disk, read-only memory (ROM), random access memory (RAM), diskette and compact disk.

In the description of the present disclosure, it should be noted that orientation or positional relationships indicated by terms such as “center”, “upper”, “lower”, “left”, “right”, “vertical”, “horizontal”, “inner”, and “outer” are based on orientation or positional relationships as shown in the drawings, merely for facilitating the description of the present disclosure and simplifying the description, rather than indicating or implying that related devices or elements have to be in the specific orientation, or configured and operated in a specific orientation, therefore, they should not be construed as limitation on the present disclosure. Besides, terms “first”, “second”, and “third” are merely for descriptive purpose, but should not be construed as indicating or implying importance in the relativity.

Finally, it should be noted that the above embodiments are merely specific embodiments of the present disclosure, for illustrating the technical solutions of the present disclosure, rather than limiting the present disclosure, and the scope of protection of the present disclosure should not be limited thereto. While the detailed description is made to the present disclosure with reference to the preceding embodiments, those ordinarily skilled in the art should understand that within the technical scope disclosed in the present disclosure, anyone familiar with the present technical field still can make modifications or readily envisage changes for the technical solutions recited in the preceding embodiments, or make equivalent substitutions to some of the technical features therein. These modifications, changes, or substitutions do not make the essence of the corresponding technical solutions depart from the spirit and scope of the technical solutions of the embodiments of the present disclosure, and they all should be covered within the scope of protection of the present disclosure. Therefore, the scope of protection of the present disclosure should be subject to the protection scope of the claims.

What is claimed is:

1. A fault-tolerant control method of a floating wind turbine, comprising steps of:
acquiring a low-order nonlinear model of a pre-established floating wind turbine;
establishing a switching linear model of the floating wind turbine based on the low-order nonlinear model, wherein the switching linear model comprises a plurality of sub-models;
acquiring a modal parameter of the current floating wind turbine, and determining, based on the modal parameter, a sub-model that the floating wind turbine currently satisfies;
establishing a switching sliding mode surface and a full-order state observer of the floating wind turbine based on the sub-model and the modal parameter; and
calculating a feedback output of a controller of the floating wind turbine according to the switching sliding mode surface and the full-order state observer, so as to perform a fault-tolerant control on the floating wind turbine through the feedback output of the controller.

2. The method according to claim 1, wherein the low-order nonlinear model comprises a drive-train model, a tower-top-displacement model and a pitch-angle model of the floating wind turbine; and
the method further comprises:
acquiring a total axial force and a rotational moment of a rotor of the floating wind turbine; and
establishing the drive-train model and the tower-top-displacement model based on the total axial force and the rotational moment.

3. The method according to claim 2, wherein the step of establishing a switching linear model of the floating wind turbine based on the low-order nonlinear model comprises:
acquiring a steady-state point linearization expression comprising the total axial force and the rotational moment; and
determining the switching linear model of the floating wind turbine based on the steady-state point linearization expression.

4. The method according to claim 3, wherein the steady-state point linearization expression is expressed as:
δTᵣ=K_{Tω}δωᵣ+K_{Tβ}δβ+K_{Tv}δv+K_{Tξ}δ\ddot{ξ}
wherein δ represents a deviation between a current value and a steady-state value of a following variable, Tᵣ represents the rotational moment, ωᵣ represents a rotor rotational speed, β represents a pitch angle, v represents a wind speed, ξ represents a second derivative of a tower-top displacement, and K_{Tω}, K_{Tβ}, K_{Tv}, and K_{Tξ} all represent dynamic gains;
the switching linear model is expressed as:
$$\{ \begin{matrix}\dot{x} ( t ) = {A}_{σ ( t )} x ( t ) + {B}_{σ ( t )} {u}_{c} ( t ) + {B}_{d , σ ( t )} w ( t ) \\ y ( t ) = {C}_{σ ( t )} x ( t ) + {D}_{σ ( t )} {u}_{c} ( t ) + {H}_{d , σ ( t )} w ( t )\end{matrix}$$
x(t), u_{c}(t), w(t), and y(t) represent parameters of a state vector, a control input, a disturbance vector, and a system output over time respectively, σ(t) represents a switch signal, wherein the switch signal is used for instructing the sub-model that the floating wind turbine currently satisfies to switch among the plurality of the sub-models, and the switch signal is constrained by an average residence time; and A, B, C, D, and H represent coefficient matrixes corresponding to the switch signal respectively.

5. The method according to claim 4, wherein the step of determining based on the modal parameter the sub-model that the floating wind turbine currently satisfies comprises:
determining, according to a preset corresponding relationship between modal parameters and switch signals, determining the switch signal according to the modal parameter; and
instructing the sub-model according to the switch signal.

6. The method according to claim 1, wherein the step of establishing a switching sliding mode surface and a full-order state observer of the floating wind turbine based on the sub-model and the modal parameter comprises:
acquiring historical modal parameters that meet a preset condition, wherein the preset condition comprises: using, under a constant wind speed and a regular wave, a gain scheduling proportional integral control strategy to control the pre-established floating wind turbine, and the historical modal parameters are steady-state values of modal parameters obtained under the preset condition;
calculating model parameters of the sub-model according to the historical modal parameters; and
establishing the switching sliding mode surface and the full-order state observer of the floating wind turbine according to the model parameters.

7. The method according to claim 6, wherein the feedback output of the controller of the floating wind turbine comprises: a compensation value feedback output of the full-order state observer, a state feedback output of the floating wind turbine, and a disturbance feedback output; and
the step of calculating a feedback output of a controller of the floating wind turbine according to the switching sliding mode surface and the full-order state observer comprises:
calculating the compensation value feedback output, the state feedback output, and the disturbance feedback output, respectively; and
superimposing the compensation value feedback output, the state feedback output, and the disturbance feedback output, to generate the feedback output of the controller of the floating wind turbine.

8. (canceled)

9. An electronic device, comprising a memory, a processor, and a computer program stored on the memory and operable on the processor, wherein when the processor executes the computer program, the steps of the method according to claim 1 are implemented.

10. A non-volatile computer-readable storage medium, wherein a computer program is stored on the non-volatile computer-readable storage medium, and when the computer program is operated by a processor, the steps of the method according to claim 1 are executed.
